(19) United States
(12) Patent Application Publication
(10) Pub. No.: US 2012/0269146 A1
(43) Pub. Date: Oct. 25, 2012

(54) Uplink Channel Sounding

(76) Inventors: Kari Pekka Pajukoski, Oulu (FI); Esa Tapani Tiirola, Kempele (FI); Kari Juhani Hooli, Oulu (FI)

(21) Appl. No.: 13/505,375

(22) PCT Filed: Nov. 2, 2009
(86) PCT No.: PCT/EP2009/064447

§ 371 Date: Jul. 2, 2012

(51) Int. Cl. H04W 72/12

(52) U.S. Cl. 370/329

(57) ABSTRACT

The invention is related to an apparatus including at least one processor and at least one memory including a computer program code, the at least one memory and the computer program code configured to, with the at least one processor, cause the apparatus at least to: configure a reference signal for uplink sounding; and arrange transmission of the reference signal for uplink sounding by using at least one of the following: scheduling downlink data for a physical downlink shared channel; configuring a transmission of a periodic channel state information or rank indicator for the physical downlink shared channel; configuring a periodic transmission for transmission on a scheduling request resource on a physical uplink control channel; and configuring a periodic transmission of a reference signal for transmission on an existing physical uplink control channel.

### FIELD

The invention relates to an apparatus, method, computer program and computer program embodied on a computer readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

The evolvement of communications technologies, launching of different services attainable wirelessly, generally speaking a requirement for increased data rates, has lead to need to develop also the communication standards. One of the standards providing higher data rates is 3GPP long-term evolution (LTE) and 3GPP long-term evolution advanced (LTE-A).

One target of the development of the LTE-A standard is to reach requirements defined in International Mobile telecommunications Advanced (IMT-A). These include enhancement in performance, such as higher data rates compared to LTE, for example.

The standards providing higher data rates usually deploy multiantenna techniques, such as different multiple input-multiple output (MIMO) techniques. This increases demands set for antenna usage and control.

### BRIEF DESCRIPTION

According to an aspect of the present invention, there is provided an apparatus comprising: at least one processor and at least one memory including a computer program code the at least one memory and the computer program code configured to, with the at least one processor, cause the apparatus at least to: configure a reference signal for uplink sounding, and arrange transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

According to yet another aspect of the present invention, there is provided a method comprising: configuring a reference signal for uplink sounding, arranging transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

According to yet another aspect of the present invention, there is provided an apparatus comprising: means for configuring a reference signal for uplink sounding, means for arranging transmission of the reference signal for uplink sounding by using at least one of the following: means for scheduling downlink data for a physical downlink shared channel, means for configuring a transmission of a periodic channel state information or rank indicator for the physical downlink shared channel, means for configuring a periodic transmission for transmission on a scheduling request resource on a physical uplink control channel, and means for configuring a periodic transmission of a reference signal for transmission on an existing physical uplink control channel.

According to yet another aspect of the present invention, there is provided a computer program embodied on a computer readable medium, configured to control a processor to perform a method, the method comprising:

configuring a reference signal for uplink sounding, arranging transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

### LIST OF DRAWINGS

Embodiments of the present invention are described below, by way of example only, with reference to the accompanying drawings, in which

FIG. 1 illustrates an example of a system;

FIG. 2 depicts a flow chart;

FIG. 3 illustrates an embodiment of an apparatus.

### DESCRIPTION OF SOME EMBODIMENTS

The following embodiments to be described are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The embodiments will be described with reference to the accompanying drawings, in which some, but not all embodiments of the invention are shown. Indeed, the invention may be embodied in many different forms and should not be construed as limited to the embodiments set forth herein.

Embodiments are applicable to any user device, such as a user terminal, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of an access architecture to which the embodiments may be applied, a radio access architecture based on LTE Advanced, LTE-A, that is based on OFDMA in a downlink and a single-carrier frequency-division multiple access SC-FDMA in an uplink, without restricting the embodiments to such an architecture, however.

In an Orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a NodeB needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the NodeB.

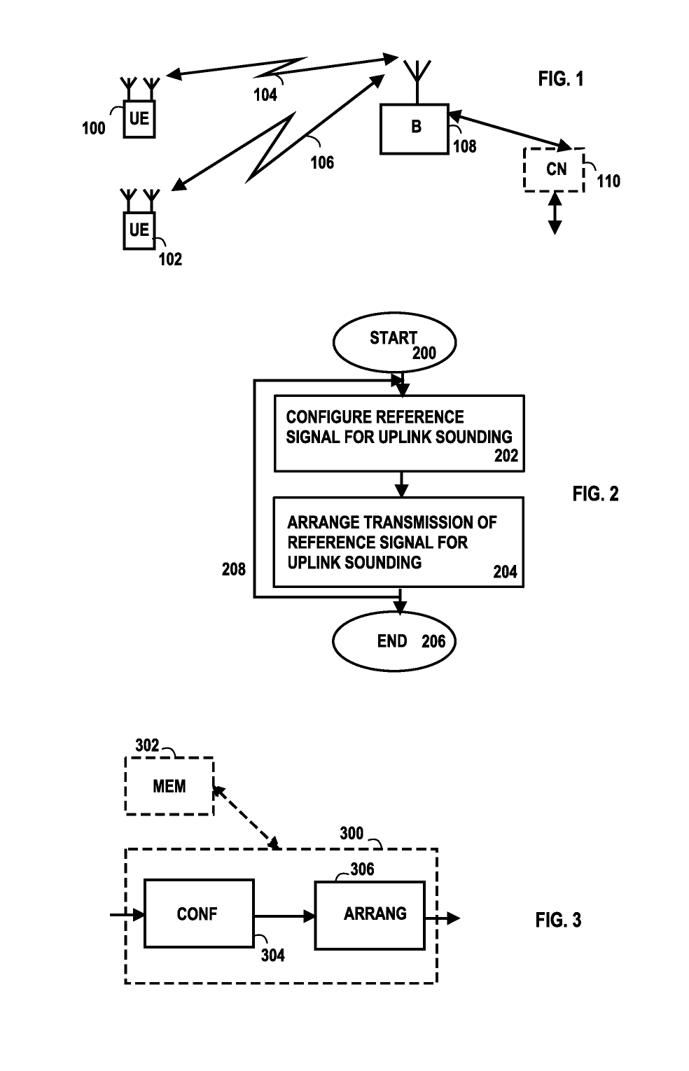

FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with the necessary properties.

FIG. 1 shows a part of a radio access network of E-UTRA, LTE or LTE-A. E-UTRA is an air interface of Release 8. Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a NodeB 108 providing the cell. The physical link from a user device to a NodeB is called uplink or reverse link and the physical link from the NodeB to the user device is called downlink or forward link.

The NodeB, or advanced evolved node B (eNodeB), is a computing device configured to control the radio resources of communication system it is coupled to. The NodeB may also be referred to a base station, an access point or any other type of interfacing device including a relay station capable of operating in a wireless environment.

The NodeB includes transceivers, for instance. From the transceivers of the NodeB, a connection is provided to an antenna unit that establishes bi-directional radio links to the user devices. The NodeB is further connected to a core network 110 (CN). Depending on the system, the counterpart on the CN side can be a serving system architecture evolution (SAE) gateway (routing and forwarding user data packets), packet data network gateway (PDN GW), for providing connectivity to user devices (UEs) to external packet data networks, or mobile management entity (MME), etc.

The communication system is also able to communicate with other networks, such as a public switched telephone network or the Internet.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device.

The user device (or a layer 3 relay node) is configured to perform one or more of user equipment functionalities described below with an embodiment, and it may be configured to perform functionalities from different embodiments. The user device may also be called a subscriber unit, mobile station, remote terminal, access terminal, user terminal or user equipment (UE) just to mention but a few names or apparatuses.

It should be understood that, in the FIG. 1, user devices are depicted to include two antennas only for the sake of clarity. The number of reception and/or transmission antennas may naturally vary according to a current implementation.

It is obvious for a person skilled in the art that the depicted system is only an example of a part of a radio access system and in practise, the system may comprise a plurality of NodeBs, the user device may have an access to a plurality of radio cells and the system may comprise also other apparatuses, such as physical layer relay nodes or other network elements.

Further, although the apparatuses have been depicted as single entities, different units, processors and/or memory units (not all shown in FIG. 1) may be implemented.

The LTE and LTE-A systems utilize various MIMO technologies including transmit diversity, single user (SU)-MIMO, multiuser (MU)-MIMO, closed-loop precoding, and dedicated beamforming.

The SU-MIMO scheme is applied to the physical downlink shared channel (PDSCH). There are two operation modes in SU-MIMO spatial multiplexing: the closed-loop spatial multiplexing mode and the open-loop spatial multiplexing mode.

In the LTE-A systems, the SU-MIMO scheme is also applied to a physical uplink shared channel (PUSCH) for user devices having more than one transmission antennas. At least two operation modes for SU-MIMO user devices are provided: a closed-loop spatial multiplexing mode and single antenna port mode.

MIMO indicates the use of multiple antennas at both the transmitter and receiver ends to improve communication performance (higher throughput, greater capacity, or improved reliability, or any combination thereof). It is usually classified into forms of smart antenna technology. MIMO systems can be divided in two classes: single-user MIMO, and multi-user MIMO. One target of the single-user MIMO (SU-MIMO) operation is typically to increase peak data rate per user device, whereas in multi-user MIMO (MU-MIMO), one target is typically to increase sector (or cell) capacity. MIMO exploits spatial multiplexing to provide increased throughput and reliability, MU-MIMO exploits multi-user multiplexing (or multi-user diversity) to further gains in capacity. Additionally, MU-MIMO benefits from spatial multiplexing even when user equipment has a single reception antenna.

In the closed-loop spatial multiplexing mode, the NodeB applies spatial domain precoding to a transmitted signal on the basis of a precoding matrix indicator (PMI) signalled for a user device. To support the closed-loop spatial multiplexing in the downlink, the user device signals as a feedback a rank indicator (RI), a PMI, and a channel quality indicator (CQI) in the uplink. The RI indicates the number of spatial layers that can be supported. The NodeB may decide the transmission rank (number of spatial layers) taking into account the RI as well as other factors such as traffic pattern, available transmission power, etc. The CQI feedback indicates a combination of modulation scheme and a channel coding rate.

A reference signal (RS) is a pre-defined signal, known to both a transmitter and a receiver in the ends of a link. The RS is typically transmitted for the receiver being able to estimate a radio channel that is to make channel estimates as well as to carry out coherent combining and detection. It should be appreciated that RS can also be transmitted for other purposes, such as synchronization. A RS may also be called as a pilot signal, for instance. In the LTE uplink, reference signals are used as demodulation reference signals (DM RS) on physical uplink control channel (PUCCH) and physical uplink shared channel (PUSCH), and as sounding reference signals (SRS). Additionally, reference signals are used for sequence modulation on PUCCH.

In the case of closed-loop SU-MIMO precoding in the uplink, a NodeB selects the precoding vector based on an antenna specific sounding reference signal transmitted from a user device. Uplink reference signals are used for channel estimation in a receiver of NodeB. The reference signals also provide channel quality information as a basis for scheduling decisions which is also called channel sounding.

Up-to-date sounding signal is not always available and precoding vector selection is therefore made according to long term spatial covariance matrix between the antennas of a user device. Also, it is generally understood that long term spatial covariance matrix will be utilized in collaborated multiantenna system in both downlink and uplink. It is believed that collaborated beamforming will be included in LTE in release 10 or later. In the simplest form of collaborated beamforming, the precoding vector is selected such that interference generated to other cells is considered together with own cell signal and interference-to-noise ratio (SINR). The spatial covariance matrix may be used in a precoder/beam selection in a manner increasing signal strength towards the desired receiver and reducing interference towards other receivers.

During standardization, it has been decided that uplink SU-MIMO supports precoded single/multistream transmission on physical uplink shared channel (PUSCH). The precoding is based on predefined codebooks, it is applied for both data signal (PUSCH) and demodulation reference signal (DMRS) in a corresponding manner. On the other hand, a sounding reference signal (SRS) is antenna specific and non-precoded. It should be noted that it is possible to configure a SU-MIMO capable user device to a single-antenna-port mode that is the user device appears as a single-antenna transmission device for an eNB.

In the LTE or LTE-A uplink, non-data associated control signalling is transmitted on a physical uplink control channel (PUCCH) located on the edges of system bandwidth. Another option is to transmit uplink control signals on a physical uplink shared channel (PUSCH) multiplexed with uplink data. For example: a user device indicates a need for uplink resource by transmitting a scheduling request indicator on PUCCH channel. For LTE-A, regarding multiantenna operation on PUCCH, it has been decided that spatial orthogonal-resource transmission diversity (SORTD) can be applied. In SORTD, different orthogonal PUCCH resources are reserved for different antenna ports. It should be appreciated that the PUCCH does not support higher order transmission diversity than 2. In other words, the maximum number of (antenna-port-specific) PUCCH resources reserved to a SU-MIMO user device is 2. If more transmission antennas are provided, for example 4, one antenna port signal includes signals from 2 virtualized antennas.

As already stated above, antenna specific up-to-date sounding signal is not always available. For example, in the case of initial access (after receiving random access message 3), SRS is not yet available (user device is operating in a single-antenna-port mode). Semi-static SRS configuration takes some time, and closed-loop precoding based on SRS is only possible when antenna-specific SRS signal is available. On the other hand, an acknowledgement/non-acknowledgement (ACK/NACK) channel on PUCCH is already available after the system information is read and the corresponding physical downlink shared channel (PDSCH) resource allocation is granted in the downlink.

In LTE Rel-8, one problem with SRS is that SRS configuration is carried out with higher layer signalling which is quite a heavy process, and also semi-static. It is thus preferable to restrict the number of SRS configurations. Additionally, a need for checking that no collisions with sounding reference signals having at least one of: different periodicity, bandwidth allocation, frequency hopping configuration, etc, do not take place. Thus, a need for a more dynamic SRS configuration or an alternative uplink sounding arrangement exists.

In the following, an embodiment of a method for uplink sounding is explained in more detail. Embodiments are well-suited for channel sounding for single-user MIMO terminals (SU-MIMO). It is believed that precoded SU-MIMO with 2 or 4 transmission antennas at a user device will be used in LTE-A, at least. However, embodiments suit for 1-antenna applications (for example for an uplink multi-cell MU-MIMO) as well.

The embodiment starts in block 200.

In block 202, a reference signal for uplink sounding is configured. This may be carried out similarly to that of Rel-8 sounding reference signal or Rel-8 PUCCH configuration, etc.

In block 204, transmission of the reference signal for uplink sounding is arranged by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

In an embodiment, the scheduling downlink data for the physical downlink shared channel generates acknowledgement/non-acknowledgement (ACK/NACK) transmission in the uplink on a physical uplink control channel format 1a/1b. It should be appreciated that an ACK/NACK channel is already available after the system information is read and the corresponding physical downlink shared channel (PDSCH) resource allocation is granted in the downlink.

In an embodiment, the configuring the transmission of the periodic channel state information or rank indicator for the physical downlink shared channel generates a transmission on a physical uplink control channel format 2/2a/2b. The configuring of PUCCH format 2/2a/2b may be carried out by using higher layer signalling.

In an embodiment, the configuring of the physical uplink control channel for the periodic transmission on the scheduling request resource is carried out by using a physical uplink control channel format 1 channel. The configuring of a PUCCH format 1 channel may be carried out using higher layer signalling. For instance, a Rel-8-type scheduling request may be used in the case of preconfigured resources, when a user device transmits a positive scheduling request indicator (SRI). If a user device has a pending scheduling request (SR) to transmit, it transmits a positive (or ON) scheduling request indicator (SRI) on its next available SR channel. Another option is to transmit a periodic signal which uses an SR-format, but does not convey SR-information.

A physical uplink control channel comprising the reference signal for uplink sounding may further be orthogonalized between adjacent cells either in a code domain or in frequency domain. A non-precoded antenna signal may be configured for transmission in such a way that an orthogonal resource is reserved for both antenna signals The antenna signals may be any PUCCH signals, such as ACK/NACK (format 1a/1b, SR (format 1), CQI/RI (format 2/2a/2b, etc).

In an embodiment, wherein 2 transmission antennas and antenna ports are provided and wherein the antenna ports are configured to reserve at least one control channel resource, a first antenna port is configured to transmit a signal by using a first antenna, and a second antenna port is configured to transmit a signal by using a second antenna.

Following embodiments are well-suited for spatial orthogonal-resource transmission diversity (SORTD) case: the embodiment provides an antenna virtualization method enabling spatial covariance matrix estimation, when a user terminal has 4 transmission antennas and the number of available orthogonal resources on a physical uplink control channel is 2. In SORTD, different orthogonal resources are reserved for different antenna ports.

One of the most typical antenna configurations for 4 transmission antennas includes 2 dual-polarized and spatially separated antenna elements. In other words, each antenna element has two polarization branches, i.e., two antennas having different polarization. This kind of arrangement exploits both space and polarization diversity. Different polarization levels are typically almost fully uncorrelated, whereas strong correlation exists between spatially separated antenna elements.

It should be appreciated that PUCCH (at least at the moment) does not support higher order diversity than 2. Thus, in the case of more transmission antennas, such as 4, one antenna port signal is designed to comprise signals from more than one virtualized antennas, such as 2. In the following, especially in the context of antenna virtualization, an antenna port corresponds to group of more than one virtualized antennas.

An example of an antenna element suitable for this embodiment includes at least 2 dual-polarized antennas and the first antenna port is configured to transmit a signal which is a combination of signals from both polarization branches of the first antenna element. An antenna port reserves a resource of a control channel.

First of the embodiments well-suited for spatial orthogonal-resource transmission is (when more than 2 transmission antennas and 2 antenna ports are provided) grouping the transmission antennas for transmission on the physical uplink control channel in such a manner that a first antenna port is configured to transmit a signal by using first dual-polarized antenna elements and a second antenna port is configured to transmit a signal by using second spatially separated dual-polarized antenna elements.

Second is grouping the transmission antennas for transmission on the physical uplink control channel in such a manner that a specified subset of antennas is configured to transmit a signal at a specified moment, and different subsets of antennas have different moments specified.

Third is (when more than 2 transmission antennas are provided) grouping the transmission antennas for transmission on the physical uplink control channel in such a manner that a specified subset of antennas is configured to transmit a signal at a specified moment.

Fourth is (when more than 2 transmission antennas are provided) grouping the transmission antennas for transmission on the physical uplink control channel in such a manner that a first antenna port is configured to transmit a signal by using a group of spatially separated antenna elements, and a second antenna port is configured to transmit a signal by using a second group of spatially separated antenna elements.

The transmission antennas may be separated into groups in such a manner that spatial correlation between the transmission antennas within each group is minimized.

An estimated spatial correlation matrix may be utilized for NodeB's precoder selection in the uplink. Estimated spatial correlation may also be used in the collaborated beamforming between cells in both uplink and downlink. In the collaborated beamforming a user device may be configured to transmit on an inter-cell orthogonal physical uplink control channel in such a manner that simultaneous estimation of spatial correlation between antennas of a user device is enabled from multiple adjacent cells.

The embodiment ends in block 206. The embodiment is repeatable in many different ways. Arrow 208 shows one example.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. The signaling messages are only exemplary and may even comprise several separate messages for transmitting the same information. In addition, the messages may also contain other information.

An embodiment provides an apparatus which may be any user device able to carry out processes described above in relation to FIG. 2.

FIG. 3 illustrates a simplified block diagram of an apparatus according to an embodiment of the invention. It should be appreciated that the apparatus may also include other units or parts than those depicted in FIG. 3. Although the apparatus has been depicted as one entity, different modules and memory may be implemented in one or more physical or logical entities.

The apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as C, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a user device, or a corresponding component, may be configured as a computer or a microprocessor, such as single-chip computer element, or as a chipset, including at least a memory for providing storage capacity used for arithmetic operation and an operation processor for executing the arithmetic operation.

As an example of an apparatus according to an embodiment, it is shown an apparatus, such as a user device or user terminal, including facilities in a control unit 300 (including one or more processors, for example) to carry out functions of embodiments, such as configuring and arranging transmissions. This is depicted in FIG. 3.

The apparatus may also include at least one processor 300 and at least one memory 302 including a computer program code, the at least one memory and the computer program code configured to, with the at least one processor, cause the apparatus at least to: configure a reference signal for uplink sounding, and arrange transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

Another example of an apparatus comprises means 304 for configuring a reference signal for uplink sounding, and means 306 for arranging transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

In the case of antenna grouping, means 306 for arranging may further carry out the grouping of transmission antennas. The means for arranging may also carry out controlling of orthogonalization and collaborated beamforming.

Yet another example of an apparatus comprises a configurer 304 configured to configure a reference signal for uplink sounding, and an arranger 306 configured to arrange transmission of the reference signal for uplink sounding by using at least one of the following: scheduling downlink data for a physical downlink shared channel, configuring a transmission of a periodic channel state information or rank indicator for the physical downlink shared channel, configuring a periodic transmission for transmission on a scheduling request resource on a physical uplink control channel, and configuring a periodic transmission of a reference signal for transmission on an existing physical uplink control channel.

In the case of antenna grouping, an arranger 306 may further be configured to carry out the grouping of transmission antennas.

The arranger may also carry out controlling of orthogonalization and collaborated beamforming.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control depending on the implementation, etc. The apparatus may utilize a transmitter and/or receiver which are not included in the apparatus itself, such as a processor, but are available to it, being operably coupled to the apparatus.

An embodiment provides a computer program embodied on a distribution medium, comprising program instructions which, when loaded into an electronic apparatus, constitute the apparatus as explained above.

Another embodiment provides a computer program embodied on a computer readable medium, configured to control a processor to perform embodiments of the method described above.

The computer program may be in source code form, object code form, or in some intermediate form, and it may be stored in some sort of carrier or a distribution medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium may be a record medium, computer memory, read-only memory and software distribution package.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and
at least one memory including a computer program code the at least one memory and the computer program code configured to, with the at least one processor, cause the apparatus at least to:
configure a reference signal for uplink sounding; and
arrange transmission of the reference signal for uplink sounding by using at least one of the following:
scheduling downlink data for a physical downlink shared channel;
configuring a transmission of a periodic channel state information or rank indicator for the physical downlink shared channel;
configuring a periodic transmission for transmission on a scheduling request resource on a physical uplink control channel; and
configuring a periodic transmission of a reference signal for transmission on an existing physical uplink control channel.

2. The apparatus of claim 1, wherein 2 transmission antennas and antenna ports are provided, the antenna ports being configured to reserve at least one control channel resource, the apparatus being further configured to: configure a first antenna port to transmit a signal by using a first antenna; and configure a second antenna port to transmit a signal by using a second antenna.

3. The apparatus of claim 1, wherein more than 2 transmission antennas and 2 antenna ports are provided, the antenna ports being configured to reserve at least one control channel resource, the apparatus being further configured to:
group the transmission antennas for a transmission on the physical uplink control channel in such a manner that a first antenna port is configured to transmit a signal by using first dual-polarized antenna elements and a second antenna port is configured to transmit a signal by using second spatially separated dual-polarized antenna elements.

4. The apparatus of claim 1, wherein more than 2 transmission antennas are provided, the apparatus being further configured to:
group the transmission antennas for transmission on the physical uplink control channel in such a manner that a specified subset of antennas is configured to transmit a signal at a specified moment.

5. The apparatus of claim 1, wherein more than 2 transmission antennas are provided, the apparatus being further configured to:
group the transmission antennas for transmission on the physical uplink control channel in such a manner that a first antenna port is configured to transmit a signal by using a group of spatially separated antenna elements, and a second antenna port is configured to transmit a signal by using a second group of spatially separated antenna elements.

6. The apparatus of claim 1, wherein the reference signal for uplink sounding is used in precoder selection in NodeB.

7. The apparatus of claim 1, the apparatus being further configured to:
orthogonalize the physical uplink control channel comprising the reference signal for uplink sounding between adjacent cells either in a code domain or in frequency domain.

8. The apparatus of claim 1, wherein the reference signal for uplink sounding is used in precoder selection with collaborated beamforming.

9. The apparatus of claim 1, wherein 2 transmission antennas are provided, the apparatus being further configured to:
configure a transmission of a non-precoded antenna signal to be transmitted in such a way that an orthogonal resource is reserved for both antenna signals.

10. The apparatus of any of claim 1, wherein the scheduling downlink data for the physical downlink shared channel generates acknowledgement/non-acknowledgement (ACK/NACK) transmission in the uplink on a physical uplink control channel format 1a/1b.

11. The apparatus of claim 1, wherein the configuring the transmission of the periodic channel state information or rank indicator for the physical downlink shared channel generates a transmission on a physical uplink control channel format 2/2a/2b.

12. The apparatus of claim 1, wherein the configuring the physical uplink control channel for the periodic transmission on the scheduling request resource is carried out by using a physical uplink control channel format 1 channel.

13. The apparatus of claim 1, the apparatus comprising a user terminal.

14. (canceled)

15. A method comprising:
configuring a reference signal for uplink sounding;
arranging transmission of the reference signal for uplink sounding by using at least one of the following:
scheduling downlink data for a physical downlink shared channel;
configuring a transmission of a periodic channel state information or rank indicator for the physical downlink shared channel;
configuring a periodic transmission for transmission on a scheduling request resource on a physical uplink control channel; and
configuring a periodic transmission of a reference signal for transmission on an existing physical uplink control channel.

16. The method of claim 15, wherein 2 transmission antennas and antenna ports are provided, the antenna ports being configured to reserve at least one control channel resource, the method further comprising:
configuring a first antenna port to transmit a signal by using a first antenna; and
configuring a second antenna port to transmit a signal by using a second antenna.

17. The method of claim 15, wherein more than 2 transmission antennas and 2 antenna ports are provided, the antenna ports being configured to reserve at least one control channel resource, the method further comprising:
grouping the transmission antennas for a transmission on the physical uplink control channel in such a manner that a first antenna port is configured to transmit a signal by using first dual-polarized antenna elements and a second antenna port is configured to transmit a signal by using second spatially separated dual-polarized antenna elements.

18. The method according to claim 15, wherein more than 2 transmission antennas are provided, the method further comprising:
grouping the transmission antennas for transmission on the physical uplink control channel in such a manner that a specified subset of antennas is configured to transmit a signal at a specified moment.

19. The method according to claim 15, wherein more than 2 transmission antennas are provided, the method further comprising:
grouping the transmission antennas for transmission on the physical uplink control channel in such a manner that a first antenna port is configured to transmit a signal by using a group of spatially separated antenna elements, and a second antenna port is configured to transmit a signal by using a second group of spatially separated antenna elements.

20. The method of claim 15, wherein the reference signal for uplink sounding is used in precoder selection in NodeB.

21. The method according to claim 15, further comprising:
orthogonalizing the physical uplink control channel comprising the reference signal for uplink sounding between adjacent cells either in a code domain or in frequency domain.

22. The method according to claim 15, wherein the reference signal for uplink sounding is used in precoder selection with collaborated beamforming.

23. The method according to claim 15, wherein 2 transmission antennas are provided, the method further comprising:
configuring a transmission of a non-precoded antenna signal to be transmitted in such a way that an orthogonal resource is reserved for both antenna signals.

24. The method according to claim 15, wherein the scheduling downlink data for the physical downlink shared channel generates acknowledgement/non-acknowledgement (ACK/NACK) transmission in the uplink on a physical uplink control channel format 1a/1b.

25. The method according to claim 15, wherein the configuring the transmission of the periodic channel state information or rank indicator for the physical downlink shared channel generates a transmission on a physical uplink control channel format 2/2a/2b.

26. The method according to claim 15, wherein the configuring the physical uplink control channel for the periodic transmission on the scheduling request resource is carried out by using a physical uplink control channel format 1 channel.

27. An apparatus comprising:
means for configuring a reference signal for uplink sounding;
means for arranging transmission of the reference signal for uplink sounding by using at least one of the following:
means for scheduling downlink data for a physical downlink shared channel;
means for configuring a transmission of a periodic channel state information or rank indicator for the physical downlink shared channel;
means for configuring a periodic transmission for transmission on a scheduling request resource on a physical uplink control channel; and
means for configuring a periodic transmission of a reference signal for transmission on an existing physical uplink control channel.

28-34. (canceled)

35. A computer program embodied on a computer readable medium, configured to control a processor to perform a method, the method comprising:
configuring a reference signal for uplink sounding;
arranging transmission of the reference signal for uplink sounding by using at least one of the following:
scheduling downlink data for a physical downlink shared channel;
configuring a transmission of a periodic channel state information or rank indicator for the physical downlink shared channel;
configuring a periodic transmission for transmission on a scheduling request resource on a physical uplink control channel; and
configuring a periodic transmission of a reference signal for transmission on an existing physical uplink control channel.

36-46. (canceled)
